(19) United States
(12) Patent Application Publication
(10) Pub. No.: US 2024/0024738 A1
(43) Pub. Date: Jan. 25, 2024

(54) WEIGHTED SPORT BALL

(71) Applicant: PAISLEYS PITCHING LLC, Lakewood, CA (US)

(72) Inventor: Antoinette PAISLEY, Lakewood, CA (US)

(21) Appl. No.: 18/355,770

(22) Filed: Jul. 20, 2023

Related U.S. Application Data
(60) Provisional application No. 63/390,919, filed on Jul. 20, 2022.

(51) Int. Cl. A63B 37/08; A63B 41/02; B29D 22/04

(52) U.S. Cl. CPC A63B 37/08; A63B 41/02; B29D 22/04; A63B 2102/182

(57) ABSTRACT

This disclosure relates generally to sport ball systems, methods, and devices. More specifically, this disclosure relates to weighted sport balls, such as softballs, baseballs, footballs, volleyballs, and basketballs, used for training athletes. Even more particularly, this disclosure relates to weighted sport balls with outer shells having seams. This disclosure also relates to weighted sports balls with seams that match regulation sport ball seams.

### REFERENCE TO RELATED APPLICATIONS

This application claims priority benefit of U.S. Provisional Patent Application No. 63/390,919, filed on Jul. 20, 2022 and entitled “Weighted Sport Ball,” which is fully incorporated by reference herein in its entirety.

### BACKGROUND OF THE INVENTION

### Field of the Disclosure

This disclosure is directed generally toward weighted sport balls and methods of making the same. More specifically, this disclosure is directed toward softballs, baseballs, and similar devices that include internal weighting. Even more specifically, this disclosure is directed toward softballs, baseballs, and similar that include an internal weighting device such as pellets, small metallic balls or beads, sand, or similar, or any combination thereof, and that also include external seams.

### Description of the Related Art

A typical softball has a circumference of approximately 11-12″ and a weight of 6.25 to 7.0 oz (177-198 g). The ball is typically made of a core of kapok, cork, and/or rubber, a polyurethane mixture, or other materials known in the art. The core is typically covered in leather, and seams are included. The seams can be used by a pitcher or other thrower of the ball to provide enhanced grip, and also to provide variance in ball path when the ball is airborne.

Over the years, athletes have begun training with weighted balls that simulate a ball used in competition, but that are heavier. This heaviness allows the user to, among other things, gain strength and control over motions typically performed in competition, such as a pitching motion. Examples of such weighted training balls include medicine balls and weighted PlyoCare® balls offered by Driveline Baseball Enterprises of Kent, Washington. However, weighted balls currently on the market are often poor at simulating the look and feel of a competition ball.

### SUMMARY OF THE DISCLOSURE

One embodiment of a ball according to the present disclosure includes an outer shell with seams. A valve is formed through the outer shell, and a weighting material is included within the outer shell.

One embodiment of a method of making a ball according to the present disclosure includes the steps of molding an outer shell, forming a valve through said outer shell, and inserting a weighting material into a hollow core of said outer shell through said valve.

This has outlined, rather broadly, the features and technical advantages of the present disclosure so that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further features and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features and advantages of the various exemplary embodiments will become apparent from the following detailed description when considered in conjunction with the accompanying drawings. Where possible, the same reference numerals and characters are used to denote like features, elements, components or portions of the inventive embodiments. It is intended that changes and modifications can be made to the described exemplary embodiments without departing from the true scope and spirit of the inventive embodiments described herein as defined by the claims.

FIGS. 1-4 are photographs of weighted sport balls according to the present disclosure.

### DETAILED DESCRIPTION OF THE INVENTION

The present disclosure describes athletic balls, such as softballs and baseballs, that can be used for training purposes. One embodiment of a ball according to the present disclosure includes a hard outer shell, such as a PVC shell, and is generally hollow. Weight can be added to the inside of the ball, such as by inserting metallic pellets or small balls or beads inside the core of the hard outer shell. In this way, the weight of the ball can be increased in order to provide a better training tool for an athlete. The outer shell can include seams to better simulate a competition ball, such as a traditional softball or baseball. The seams can be molded as part of the outer shell. While much of the text herein refers specifically to softballs and baseballs, it is understood that the same ideas, concepts, devices, and methods can be applied to other types of balls, such as basketballs, soccer balls, volleyballs, footballs, etc.

Throughout this description, the preferred embodiment and examples illustrated should be considered as exemplars, rather than as limitations on the present invention. As used herein, the term “invention,” “device,” “method,” “disclosure,” “present invention,” “present device,” “present method,” or “present disclosure” refers to any one of the embodiments of the invention described herein, and any equivalents. Furthermore, reference to various feature(s) of the “invention,” “device,” “method,” “disclosure,” “present invention,” “present device,” “present method,” or “present disclosure” throughout this document does not mean that all claimed embodiments or methods must include the referenced feature(s).

It is also understood that when an element or feature is referred to as being “on” or “adjacent” to another element or feature, it can be directly on or adjacent the other element or feature or intervening elements or features may also be present. It is also understood that when an element is referred to as being “attached,” “connected” or “coupled” to another element, it can be directly attached, connected or coupled to the other element or intervening elements may be present. In contrast, when an element is referred to as being “directly attached,” “directly connected” or “directly coupled” to another element, there are no intervening elements present.

Relative terms such as “outer,” “above,” “lower,” “below,” “horizontal,” “vertical” and similar terms, may be used herein to describe a relationship of one feature to another. It is understood that these terms are intended to encompass different orientations in addition to the orientation depicted in the figures.

Although the terms first, second, etc. may be used herein to describe various elements or components, these elements or components should not be limited by these terms. These terms are only used to distinguish one element or component from another element or component. Thus, a first element or component discussed below could be termed a second element or component without departing from the teachings of the present invention. As used herein, the term “and/or” includes any and all combinations of one or more of the associated list items.

The terminology used herein is for describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “having,” and similar terms, when used herein, specify the presence of stated features, integers, steps, operations, elements, and/or components, but do not preclude the presence or addition of one or more other features, integers, steps, operations, elements, components, and/or groups thereof.

Embodiments of the invention are described herein with reference to different views and illustrations that are schematic illustrations of idealized embodiments of the invention. As such, variations from the shapes of the illustrations as a result, for example, of manufacturing techniques and/or tolerances are expected. Embodiments of the invention should not be construed as limited to the particular shapes of the regions illustrated herein but are to include deviations in shapes that result, for example, from manufacturing.

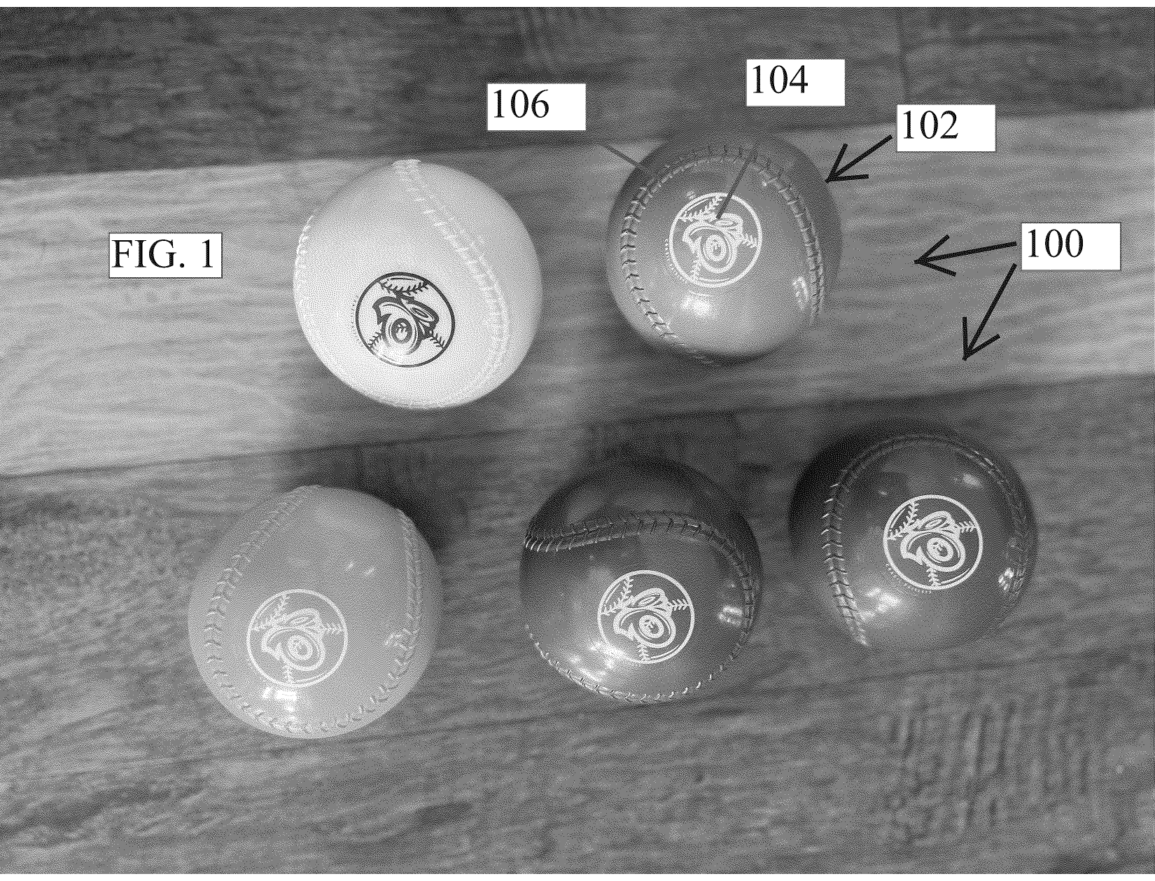

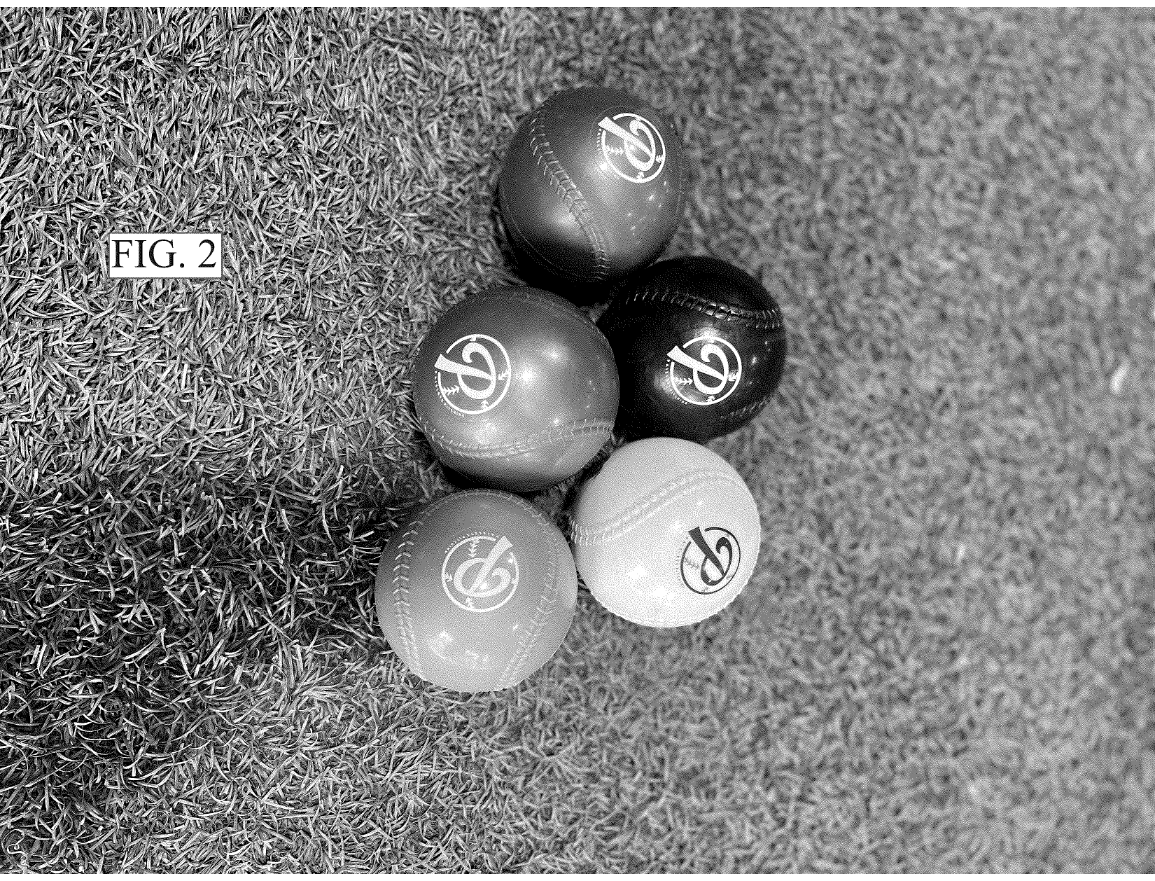

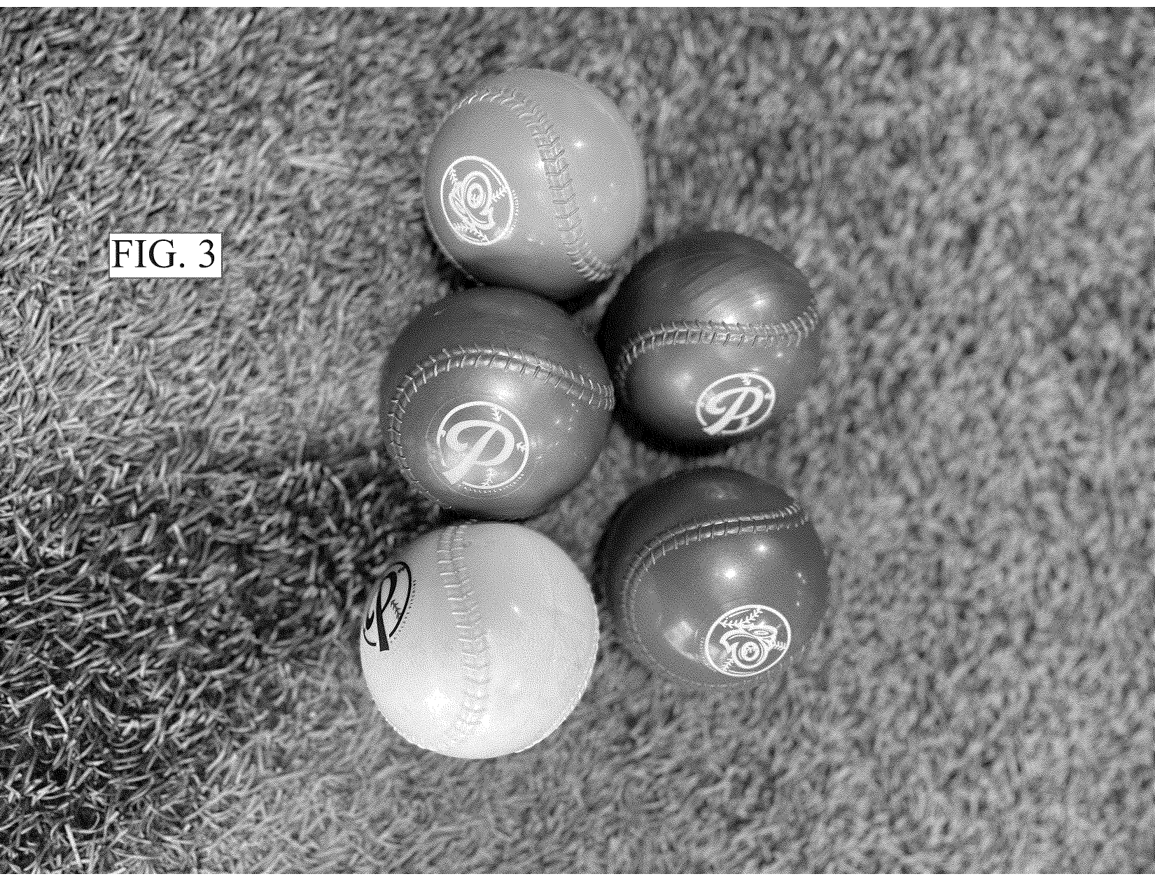

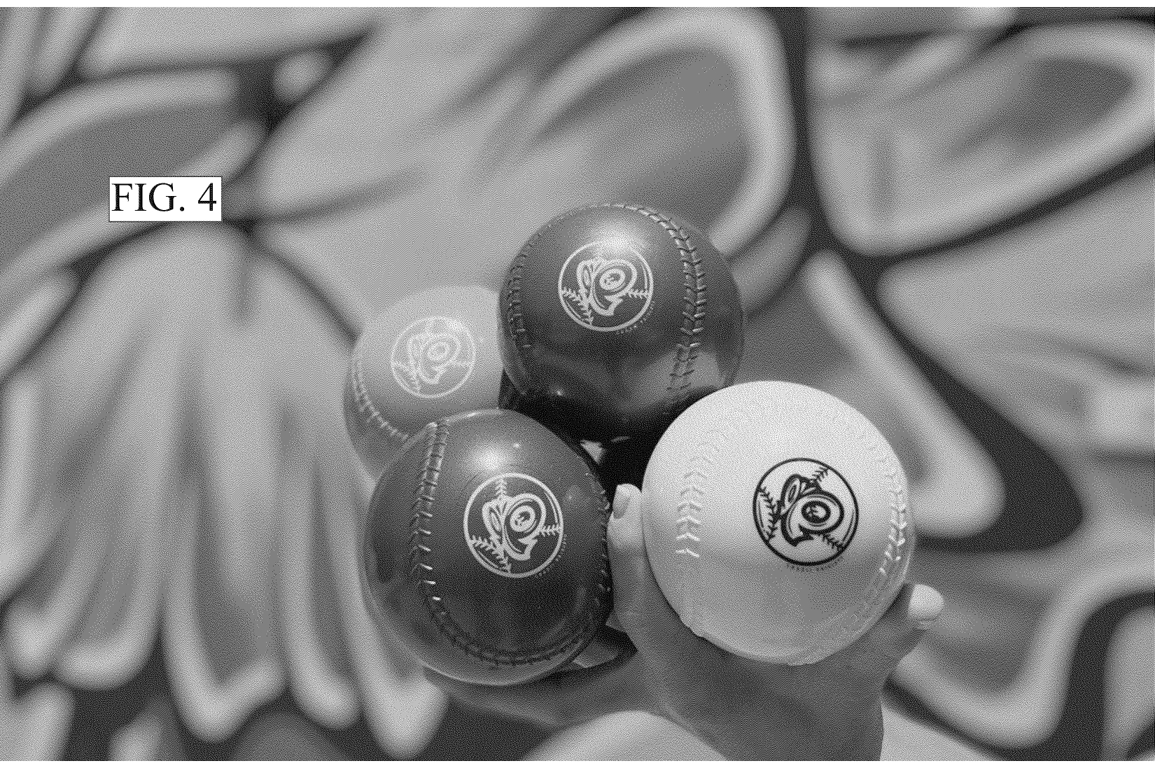

FIGS. 1-4 show various versions of a sport ball 100 according to the present disclosure. The sport ball 100 can include an outer shell 102. The outer shell 102 can be made of many different materials, such as, for example, PVC, plastic, polymers, rubber, leather, or other materials as would be understood by one of skill in the art.

The outer shell 102 can be shaped to include seams 106, which can have the same placement on the sport ball 100 as seams on a competition ball such as a regular softball or baseball (i.e., the seams are continuous and divide the outer shell 102 into two saddle-shaped portions). The outer shell 102 can be molded into the shown shape, including the seams 106. It is understood that in other embodiments, the seams may be separate from the outer shell 102. The seams 106 can be raised from the body 104 of the outer shell 102.

Compared to the prior art, the addition of the seams 106 greatly improves performance. The addition of the seams 106 enable the sport ball 100 to resemble regulation balls such as baseballs and softballs, and thus provide the user a more realistic experience. The inclusion of the seams 106 improves proprioception, finger strength, and overall grip strength. They also allow a user to practice utilizing the seams to spin the sport ball 100, like they may do to a regulation ball in a game.

The sport ball 100 can be generally hollow, forming a hollow core therein. In one specific embodiment, no inner layer is included. In another embodiment, a bladder such as a rubber bladder can be included within the outer shell 102. The sport ball 100 and/or outer shell 102 can include a valve (not shown). The valve can be used to add weight (e.g., a weighting material) to the inside of the sport ball 100. For instance, solid (e.g., metallic such as steel) and/or liquid materials such as pellets, balls or beads, types of balls or beads, sand, and/or water can be added to the inside of the sport ball 100 in order to increase the overall weight of the sport ball 100. For instance and not by way of limitation, while a regular softball can weigh approximately 6.75 oz., sport balls 100 according to the present disclosure can be overweighted to above 7 oz., such as 9 oz.±1 oz., 11 oz.±2 oz., 16 oz.±3 oz.; 32 oz.±6 oz.; 8 oz. or more; 10 oz. or more; 15 oz. or more; 20 oz. or more; or various other weights. Underweighted balls are also possible, such as 2 oz.±0.5 oz., 3 oz.±0.5 oz., 4 oz.±1 oz., 5 oz.±1 oz., 6 oz. or less, 5 oz. or less, 4 oz. or less, 2 oz. to 6 oz., 2 oz. to 5 oz., and other weights. By way of example only, overweighted balls can be used to improve strength, while underweighted balls can be used to improve arm speed and throw time. It is understood that all of these weights and ranges are exemplary in nature, and other weights are possible.

The use of solid pellets, balls, and/or beads, which can be metallic or other materials, can have distinct advantages. The use of these materials compared to, e.g., sand, allows a user to hear the noise of the material as the sport ball 100 is spun, and in some instances to better feel how the weight of the sport ball 100 is moving. This can allow the user to get a better feel for the sport ball 100 when practicing throwing with spin. The use of these materials can also allow for more rapid spinning compare to, e.g., sand.

The weight can be controlled by controlling the amount of material that is put into the sport ball 100. Many different embodiments are possible. Additionally, air can also be pumped into the sport ball 100, such as through the valve, in order to adjust the overall size and internal pressure of the sport ball 100. In some embodiments according to the present disclosure, by pumping air into the sport ball 100, the user can increase the overall diameter of the sport ball 100. In a more specific embodiment, the diameter of the sport ball 100 can be increased to a diameter greater than that of a regulation sport ball. When such a sport ball 100 is used in training, the user may become accustomed to the sport ball 100's larger diameter and thereafter perceive a regulation sport ball as relatively small and easier to grip and throw. In other embodiments, the user may decrease the diameter of the sport ball 100, for example by releasing air from the valve. In more specific embodiments, the user may decrease the diameter of the sport ball 100 to less than that of a regulation sport ball.

Space can intentionally be left within the hollow core of the sport ball 100 (i.e., the hollow core may not be completely filled with weighting material). The more space/air that is left within the hollow core, the better the ball will bounce, such as off of a wall. This can allow a user (e.g., pitcher) to play catch with herself or himself, eliminating the need for a second person during workouts. The inclusion of air also results in the ball coming back to the user more accurately after it hits an intended target.

The total amount of space/air left within the hollow core of the ball can vary. In some embodiments, the total free space within the hollow core of the ball compared to total hollow core volume can be 10% or more, 20% or more, 30% or more, 50% or more, 66% or more, 75% or more, 90% or more, 90% or less, 75% or less, 66% or less, 50% or less, 30% or less, 20% or less, 10% or less, or a range between any of these numbers. This can be measured either including or excluding the space inherently between weighting material elements due to shape (e.g., the space between steel balls in a large group of such steel balls), and is measured excluding that space unless explicitly stated otherwise.

It is understood that the various exemplary inventive embodiments described herein are intended to be merely illustrative of the principles underlying the inventive concept. It is therefore contemplated that various modifications of the disclosed embodiments will, without departing from the inventive spirit and scope, be apparent to persons of ordinary skill in the art. They are not intended to limit the various exemplary inventive embodiments to any precise form described. Other variations and inventive embodiments are possible in light of the above teachings, and it is not intended that the inventive scope be limited by this specification, but rather by the claims following herein.

Although the present invention has been described in detail with reference to certain preferred configurations thereof, other versions are possible. Embodiments of the present invention can comprise any combination of compatible features shown in the various figures, and these embodiments should not be limited to those expressly illustrated and discussed. Therefore, the spirit and scope of the invention should not be limited to the versions described above. Moreover, it is contemplated that combinations of features, elements, and steps from the appended claims may be combined with one another as if the claims had been written in multiple dependent form and depended from all prior claims. Combination of the various devices, components, and steps described above and in the appended claims are within the scope of this disclosure. The foregoing is intended to cover all modifications and alternative constructions falling within the spirit and scope of the invention.

We claim:

1. A ball, comprising:
an outer shell comprising seams;
a valve through said outer shell; and
a weighting material within said outer shell.

2. The ball of claim 1, wherein said outer shell is PVC.

3. The ball of claim 1, wherein said outer shell is leather.

4. The ball of claim 1, wherein said weighting material is selected from the group consisting of pellets, steel balls, and sand.

5. The ball of claim 1, wherein said outer shell is hollow.

6. The ball of claim 5, further comprising:
a bladder within said outer shell and connected to said valve.

7. The ball claim 1, wherein said ball weighs 20 oz. or more.

8. The ball of claim 1, wherein said seams are raised from a body of said outer shell.

9. The ball of claim 8, wherein said seams match seams of a regulation sport ball.

10. The ball of claim 1, wherein said outer shell defines a hollow core, and wherein 50% or more of said hollow core is free space.

11. A method of making a ball, comprising:
molding an outer shell;
forming a valve through said outer shell; and
inserting a weighting material into a hollow core of said outer shell through said valve.

12. The method of claim 11, wherein said outer shell comprises seams.

13. The method of claim 12, wherein said seams are molded as part of said outer shell.

14. The method of claim 13, wherein said seams are raised from a body of said outer shell.

15. The method of claim 14, wherein said seams match seams of a regulation sport ball.

16. The method of claim 12 further comprising the step of forming a bladder within said outer shell and connected to said valve.

17. The method of claim 12 further comprising the step of inserting air into said hollow core of said outer shell through said valve.

18. The method of claim 17, wherein the step of inserting air into said hollow core is repeated until the volume of said hollow core is at least 50% free space.

19. The method of claim 11, wherein the step of inserting a weighting material into a hollow core of said outer shell through said valve is repeated until said ball weighs 13 oz. or more.

20. The method of claim 11, wherein the step of inserting a weighting material into a hollow core of said outer shell through said valve is completed when said ball weighs 6 oz. or less.
